(19) United States
(12) Patent Application Publication
(10) Pub. No.: US 2021/0219580 A1
(43) Pub. Date: Jul. 22, 2021

(54) Zero-Sugar Beverage Composition

(71) Applicant: Stokely-Van Camp, Inc., Chicago, IL (US)

(72) Inventors: Joseph W. Kreger, Arlington Heights, IL (US); Christopher N. Manganais, Chicago, IL (US)

(21) Appl. No.: 15/734,073

(22) PCT Filed: May 31, 2019
(86) PCT No.: PCT/US2019/034899

§ 371 Date: Dec. 1, 2020

Related U.S. Application Data
(60) Provisional application No. 62/679,540, filed on Jun. 1, 2018.

(51) Int. Cl. A23L 2/68; A23L 2/56; A23L 29/00; A23L 2/60; A23L 29/212

(52) U.S. Cl. CPC A23L 2/68; A23L 2/56; A23L 29/212; A23L 2/60; A23L 29/035; A23L 29/015

(57) ABSTRACT

A zero-sugar beverage composition is provided that includes an electrolyte, acid, and nonnutritive sweeteners. The electrolyte blend used in the beverage has a high buffering capacity, which enables an increased amount of citric acid to be added while maintaining a pH of about 3.4. The combination of sweeteners sucralose and acesulfame potassium, electrolyte blend having high buffering capacity, citric acid, and a variety of flavoring systems provides a beverage that is well accepted by consumers.

### BACKGROUND

The present invention relates to a zero-sugar beverage composition comprising an electrolyte blend and nonnutritive sweetener.

Some consumers associate beverages containing sugar with various concerns, including weight gain and other health problems. For these consumers, the sugar content of beverages is increasingly becoming a significant dietary consideration. Consequently, reduced sugar and alternative sweetener beverages have become available in the market. Alternative sweeteners and other flavorings are perceived by some as having unfavorable sensory characteristics, including astringency, bitterness, high intensity sweet aftertaste, and mouth drying.

Beverages containing electrolytes are also available, and are intended to be consumed in conjunction with physical activity, such as exercise, to replenish fluids and electrolytes lost during the activity. Incorporation of electrolytes into beverages presents other considerations when combined with other flavors and sweeteners. For example, beverages with electrolytes are typically associated with a salty sensory attribute.

### SUMMARY

The present disclosure relates to a zero-sugar beverage having a pH of about 3.4 and comprising electrolytes in combination with nonnutritive sweeteners, including sucralose and acesulfame potassium. The electrolyte blend for the beverage has a high buffering capacity which enables an increased amount of citric acid to be added to the beverage without lowering the overall pH. The citric acid amplifies flavor intensities while the pH level reduces the perception of sensory attributes commonly associated with nonnutritive sweeteners, such as tartness, astringency, bitterness, high intensity sweet aftertaste, and dry mouth feel. One aspect of the of the present disclosure is a zero-sugar beverage comprising water, an electrolyte blend comprising sodium, chloride, potassium, and citrate, citric acid, and nonnutritive sweeteners.

These and other objects, along with advantages and features of the present disclosure, will become apparent through reference to the following description. Furthermore, it is to be understood that the features of the various embodiments described herein are not mutually exclusive and can exist in various combinations and permutations.

### DETAILED DESCRIPTION

The following terms are defined in relation to the various embodiments of the zero-sugar beverage described and claimed herein. The term “Brix,” as used herein, refers to a measure of sugar content in an aqueous solution or beverage. The term “Brix Equivalence,” as used herein, is used to describe the relative sweetness of an aqueous solution containing nonnutritive sweetener as compared to an aqueous solution containing sugar.

Nonnutritive sweeteners are often provided with a relative sweetness index which is used to calculate what the Brix would be if a sucrose solution was used to provide a similar perception of sweetness. For example, an aqueous solution containing 6 wt. % sucrose (6 g sugar per 100 g water) will have a Brix of 6° Brix. Undiluted sucralose, for example, can have a relative sweetness of 600. To achieve the same perception of sweetness (6° Brix Equivalence) using only undiluted sucralose in a solution with an actual Brix of 0° Brix, about 0.01 g sucralose is needed per 100 g water. Equation (1) below can be used to calculate Brix Equivalence, referencing exemplary relative sweetness indices of commonly accepted sweetness comparisons for certain sweeteners provided in Table 1 below.

Brix Equivalence=Relative Sweetness×Mass (g) of Sweetener per 100 g Water (1)

TABLE 1
Relative Sweetness Comparison (relative to sucrose)

| Sweetener | Relative Sweetness Index |
|---|---|
| Cyclamate | 30 times as sweet as sugar |
| Stevioside | 100-250 times as sweet as sugar |
| Acesulfame-K | 200 times as sweet as sugar |
| Mogroside V | 100-300 times as sweet as sugar |
| Rebaudioside A | 150-300 times as sweet as sugar |
| Aspertame | 200 times as sweet as sugar |
| Saccharine | 300 times as sweet as sugar |
| Neohesperidin dihydrochalcone | 300 times as sweet as sugar |
| Sucralose | 600 times as sweet as sugar |
| Neotame | 8,000 times as sweet as sugar |

It should be understood that electrolyte blends, beverages and other beverage products in accordance with this disclosure may have any of numerous different specific formulations or constitutions. The formulation of a composition in accordance with this disclosure can vary to a certain extent, depending upon such factors as the product's intended market segment, its desired nutritional characteristics, flavor profile and the like. Electrolytes are typically included in beverages to replace elements lost during physical activity, thereby improving health and endurance performance. Electrolyte blends according to embodiments of the present disclosure comprise sodium, potassium, chloride, citrate, and phosphate. In some embodiments, the electrolyte blend consists essentially of electrolyte salts, for instance sodium lactate, potassium gluconate, calcium chloride (anhydrous), potassium chloride, potassium citrate, sodium chloride, sodium acid sulfate, monopotassium phosphate, calcium lactate, magnesium oxide, sodium citrate dehydrate, or combinations thereof. In some embodiments, the beverage can comprise about 3 to 24 mEq/L citrate. For example, the beverage can comprise 7.5 to 11.4 mEq/L citrate.

In some embodiments, the electrolyte blend comprises an electrolyte source for providing sodium (Na). Sodium may be provided by sodium-containing compounds, such as sodium chloride, sodium lactate, trisodium citrate, sodium citrate dehydrate, sodium gluconate, monosodium phosphate, disodium phosphate, trisodium phosphate, tetrasodium acid pyrophosphate, sodium acid sulfate, sodium carbonate, sodium bicarbonate, sodium aspartate, sodium pyruvate, sodium acetate, sodium citrate, or combinations thereof. In some embodiments, the beverage comprises about 10 to 30 mEq/L of sodium. For example, the beverage can comprise about 15 to 25 mEq/L sodium. For example, the beverage can comprise about 20 mEq/L sodium.

In some embodiments, the electrolyte blend includes an electrolyte source for providing chloride (CI). Chloride may be provided by chloride-containing compounds, such as magnesium chloride, potassium chloride, sodium chloride, anhydrous calcium chloride, or combinations thereof. In some embodiments, the beverage comprises 4 to 22 mEq/L of chloride. For example, the beverage can comprise between 6.8 to 10.3 mEq/L of chloride.

In some embodiments, the electrolyte blend comprises an electrolyte source for providing potassium (K). Potassium may be provided by potassium-containing compounds, such as potassium chloride, potassium citrate, potassium gluconate, monopotassium phosphate, dipotassium phosphate, tripotassium phosphate, tetrapotassium pyrophosphate, potassium sulfate, potassium acetate, potassium bicarbonate, potassium bromide, or combinations thereof. In some embodiments, the beverage comprises about 2 to 5 mEq/L of potassium. In some embodiments, the beverage comprises about 1 to 10 mEq/L of phosphate. For example the beverage can comprise about 3.6 to 5.4 mEq/L of phosphate.

In addition to the electrolyte blend, nonnutritive sweeteners can also be added to the zero-sugar beverage. Suitable nonnutritive sweeteners and combinations of sweeteners are selected for the desired taste profile for the beverage, mouthfeel and other organoleptic factors. Nonnutritive sweeteners suitable for some exemplary embodiments include, for example, peptide-based sweeteners, such as aspartame, neotame, and alitame, and non-peptide-based sweeteners, such as sodium saccharin, calcium saccharin, acesulfame (including but not limited to acesulfame potassium), cyclamate (including but not limited to sodium cyclamate and/or calcium cyclamate), neohesperidin dihydrochalcone, and sucralose. It will be within the ability of those skilled in the art, given the benefit of this disclosure, to select suitable additional or alternative sweeteners for use in various embodiments of the beverage products disclosed here.

In a preferred embodiment, the nonnutritive sweetener used in the beverage of the present invention is a combination of sucralose and acesulfame potassium. In some embodiments, sucralose and acesulfame potassium can be used in a weight ratio of about 3:1 to 5:1. For example, the sucralose to acesulfame potassium weight ratio can be about 4:1. In some embodiments, the beverage can comprise about 100 to 250 mg/L of sucralose. In some embodiments, the beverage can comprise about 30 to 60 mg/L of acesulfame potassium.

It is understood that use of the term “zero-sugar beverage” in the context of the present invention is intended to exclude sucrose (table sugar) from the beverage, but does not exclude absolutely all sugars (carbohydrates) from the beverage. Some ingredients could contribute nominal amounts of sugars that raise the Brix to greater than 0. For example, the United States Food and Drug Administration regulations allow for food products with less than 0.5 grams of sugars per serving to be labeled “zero sugar.” Therefore, one skilled in the art recognizes that use herein of the term “zero-sugar beverage” allows for manufacturing tolerances that do include nominal amounts of sugars or carbohydrates in the beverage. In some embodiments, the zero-sugar beverage comprises a Brix of less than 0.55° Brix. In some embodiments, the zero-sugar beverage comprises a Brix of about 0.35° Brix to 0.55° Brix. In some embodiments, the zero-sugar beverage comprises a Brix Equivalence of about 4 to 7, including all individual values, ranges and subranges therein. For example and without limiting the scope of the present invention, the zero-sugar beverage can comprise a Brix Equivalence of: 4.5 to 6; 6 to 7; 5; or 6.9.

Acid used in the beverage disclosed herein can serve several functions, including, for example, providing antioxidant activity, lending tartness to the taste of the beverage, enhancing palatability, increasing thirst quenching effect, modifying sweetness and acting as a mild preservative by providing microbiological stability. Any suitable food-grade acid may be used, for example citric acid, malic acid, tartaric acid, phosphoric acid, ascorbic acid, lactic acid, formic acid, fumaric acid, gluconic acid, succinic acid, maleic acid, sodium acid sulfate and/or adipic acid. The acid can be used in solution form, for example, and in an amount sufficient to provide the desired pH of the beverage.

In one embodiment, the one or more acids used in the beverage total from about 0.01% to about 1.0% by weight of the beverage, e.g., from about 0.05% to about 0.5% by weight of the beverage, from about 0.1% to 0.35% by weight of the beverage, depending upon the acidulant used, desired pH, other ingredients used, etc. In some embodiments, the beverage comprises about 0.15 wt. % to about 0.3 wt. % citric acid.

In a preferred embodiment, the pH of the inventive beverage is about 3.4. The pH in previously known rehydration beverages is usually 3.0 or lower. The inventors herein have found that increasing the pH to about 3.4 reduces the perception of sensory attributes commonly associated with nonnutritive sweeteners such as tartness, astringency, bitterness, high intensity sweet aftertaste, and dry mouth feel. Adding citric acid to the beverage has the effect of lowering the overall pH of the beverage. However, the inventors have found that the electrolytes used in the present disclosure have a high buffering capacity, which allows the beverage to maintain a higher target pH at increased acid concentrations. The inventors have also discovered that the citric acid in combination with the sweeteners and flavors disclosed herein provides a palatable zero-sugar beverage. A target pH of about 3.4 under typical manufacturing conditions allows for a +/−0.3 pH variance. Therefore, when the term “about 3.4” is used herein to describe the pH of a beverage, it should be understood to include pH from 3.1 to 3.7.

In some embodiments, the beverage may optionally contain a flavor composition, for example, natural or artificial fruit flavors, botanical flavors, other flavors, and mixtures thereof. In some embodiments, flavors are present in an amount between 0 weight percent and 0.4 weight percent of the beverage. In one embodiment, the beverage comprises about 0.1 weight percent of flavor. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but that are commonly accepted as a berry. Also included within the term “fruit flavor” are flavors manufactured to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime and grapefruit, and such flavors as apple, grape, cherry, and pineapple flavors and the like, and mixtures thereof. In some exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component can further comprise a blend of various of the above-mentioned flavors. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression. In some embodiments, the zero-sugar beverage comprises lemon lime flavor. In some embodiments, the zero-sugar beverage comprises cherry lime flavor. In some embodiments, the zero-sugar beverage comprises orange flavor. In some embodiments, the zero-sugar beverage comprises fruit punch flavor. In some embodiments, the zero-sugar beverage comprises about 2 g or less carbohydrates per 240 mL.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in some exemplary embodiments will be apparent to those skilled in the art given the benefit of this disclosure. Flavorings can be in the form of an extract, oleoresin, juice concentrate, bottler's base, or other forms known in the art. In some embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In some embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. In some embodiments, the flavoring system does not comprise emulsifying agents. The inventors have discovered that beverages with a cloudy appearance are perceived well by some consumers. Flavoring systems comprising emulsifiers provide the beverage with a cloudy appearance. In some embodiments, a cloud component is added to provide a cloudy appearance. For example, the beverage can comprise about 0.005 to 0.2 weight percent of starch cloud.

The beverage concentrates and beverages disclosed herein may contain additional ingredients, including, generally, any of those typically found in beverage formulations. These additional ingredients, for example, can typically be added to a stabilized beverage concentrate. Examples of such additional ingredients include, but are not limited to, caffeine, caramel and other coloring agents or dyes, antifoaming agents, gums, and tea solids. The beverage or beverage concentrate according to different embodiments of the present invention are administered orally, and may, for example and without limitation, take the form of liquid, gel, dry powder, tablet or capsule.

Water is a basic ingredient in the beverage products disclosed here. It functions as the vehicle or primary liquid portion in which the remaining ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage. In some embodiments, the beverage comprises at least about 98 weight percent water. In some exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

### EXAMPLES

Tables 2 to 9 are examples of beverages of the present disclosure comprising an electrolyte blend, a Brix of less than 0.55° Brix, and a pH of about 3.4.

Tables 2 to 5 summarize exemplary beverages comprising a Brix Equivalence of 4°. For example, each of the beverages in Tables 2 to 5 comprise 185 mg/L of sucralose (diluted by 25 weight percent) and 37 mg/L of acesulfame potassium. The beverage of Table 2 comprises 1024 mg/L of fruit punch flavor. The fruit punch flavoring system comprises an emulsifier. The emulsifying agent provides a cloudy appearance without the need to add a clouding agent. Additionally, 2300 mg/L of citric acid is used in this example beverage.

TABLE 2
Fruit Punch Flavored Beverage (Brix Equivalence 4.0)

| Ingredient | Amount | |
|---|---|---|
| Water | 994585 | mg/L |
| Citric Acid, Anhydrous | 2300 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 185 | mg/L |
| Acesulfame Potassium | 37 | mg/L |
| Fruit Punch Flavoring | 1024 | mg/L |

Similar to the beverage of Table 2, the beverage of Table 3 comprises the same electrolyte package along with the same amount of sucralose and acesulfame potassium. The flavoring system used for the beverage of Table 3 is an orange flavoring system which comprises an emulsifier. The emulsifying agent provides a cloudy appearance without the need to add a clouding agent. Additionally, 2225 mg/L of citric acid is used in this example beverage.

TABLE 3
Orange Flavored Beverage (Brix Equivalence 4.0)

| Ingredient | Amount | |
|---|---|---|
| Water | 994660 | mg/L |
| Citric Acid, Anhydrous | 2225 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 185 | mg/L |
| Acesulfame Potassium | 37 | mg/L |
| Orange Flavoring | 1024 | mg/L |

Unlike the beverages of Tables 2 and 3, the beverage of Table 4 comprises a natural cherry lime flavoring system which does not contain an emulsifying agent. In order to create a cloudy appearance in the beverage, 1000 mg/L of starch cloud was added. Additionally 1500 mg/L of citric acid was added to maintain a pH of about 3.4.

TABLE 4
Glacier Cherry Flavored Beverage (Brix Equivalence 4.0)

| Ingredient | Concentration | |
|---|---|---|
| Water | 994385 | mg/L |
| Citric Acid, Anhydrous | 1500 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 185 | mg/L |
| Acesulfame Potassium | 37 | mg/L |
| Natural Cherry Lime Flavoring | 1024 | mg/L |
| Starch Cloud | 1000 | mg/L |

The beverage summarized in Table 5 comprises a lemon lime flavoring system without a starch cloud.

TABLE 5
Lemon Lime Flavored Beverage (Brix Equivalence 4.0)

| Ingredient | Concentration | |
|---|---|---|
| Water | 994535 | mg/L |
| Citric Acid, Anhydrous | 2350 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 185 | mg/L |
| Acesulfame Potassium | 37 | mg/L |
| Lemon Lime Flavoring | 1024 | mg/L |

The beverage summarized in Table 6 has an Brix Equivalence of 7.0°. The lemon lime beverage is sweetened using 253 mg/L of sucralose (diluted by 25 weight percent) and 49 mg/L acesulfame potassium. The ratio of sucralose to acesulfame potassium is 3.9.

TABLE 6
Lemon Lime Flavored Beverage (Brix Equivalence 7.0)

| Ingredient | Amount | |
|---|---|---|
| Water | 994405 | mg/L |
| Citric Acid, Anhydrous | 2400 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 253 | mg/L |
| Acesulfame Potassium | 49 | mg/L |
| Lemon Lime Flavoring | 1024 | mg/L |

The lemon lime beverage of Table 7 comprises the same amount of flavoring as the beverage in Table 6, except, the Brix Equivalence is 5.5°. The ratio of sucralose to acesulfame potassium was 3.8, with 215 mg/L of sucralose (diluted by 25 wt. %) and 42 mg/L of acesulfame potassium being used. In both versions of the lemon lime beverage, the citric acid level is 2400 mg/L. When comparing the three versions of lemon lime beverages (Tables 4, 5, and 6) of various Brix Equivalence values, all of the beverages were perceived to have a similar sensory profile when tested by a sensory panel. Samples were evaluated by a spectrum trained sensory descriptive panel using a 15 point intensity scale. Data was collected over two replications and the presentation order was balanced across the sensory panel. The samples were only identified using three digit blinding codes. It was noted that higher sweetness affects total aromatic impact, and Brix Equivalence greater than 6 was found to greatly increase the perception of sweetness.

TABLE 7
Lemon Lime Flavored Beverage (Brix Equivalence 5.5)

| Ingredient | Concentration | |
|---|---|---|
| Water | 994450 | mg/L |
| Citric Acid, Anhydrous | 2400 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 215 | mg/L |
| Acesulfame Potassium | 42 | mg/L |
| Lemon Lime Flavoring | 1024 | mg/L |

Similarly, Tables 8 and are 9 summarize the glacier cherry flavored beverage comprising Brix Equivalence of 7.0 and 5.5 respectfully. When compared to the beverage of Table 4 (Brix Equivalence of 4.0), all of the beverages had very similar sensory profiles. The beverages of Tables 8 and 9 were found by the sensory panel to have a stronger overall fruit and cherry intensity.

TABLE 8
Glacier Cherry Flavored Beverage (Brix Equivalence 7.0)

| Ingredient | Concentration | |
|---|---|---|
| Water | 993781 | mg/L |
| Citric Acid, Anhydrous | 2000 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 253 | mg/L |
| Acesulfame Potassium | 49 | mg/L |
| Natural Cherry Lime Flavoring | 1024 | mg/L |
| Starch Cloud | 1024 | mg/L |

The beverage of Table 9 had a stronger perception of sweetness when compared to the other two lower Brix Equivalence versions.

TABLE 9
Glacier Cherry Flavored Beverage (Brix Equivalence 5.5)

| Ingredient | Concentration | |
|---|---|---|
| Water | 993826 | mg/L |
| Citric Acid, Anhydrous | 2000 | mg/L |
| Sodium from electrolytes | 20 | mEq/L |
| Potassium from electrolytes | 3.3 | mEq/L |
| Citrate from electrolytes | 3 to 24 | mEq/L |
| Phosphate from electrolytes | 1 to 10 | mEq/L |
| Chloride from electrolytes | 4 to 22 | mEq/L |
| Sucralose (25% Dilution) | 215 | mg/L |
| Acesulfame Potassium | 42 | mg/L |
| Natural Cherry Lime Flavoring System | 1024 | mg/L |
| Starch Cloud | 1024 | mg/L |

### Additional Embodiments

The following descriptive embodiments are offered as further support of the disclosed beverage:

In a first embodiment, novel aspects described in the present disclosure are directed to a

In another aspect of the first embodiment, the zero-sugar beverage comprising: water; zero sugars; an electrolyte blend comprising sodium, chloride, potassium, and citrate; citric acid; sucralose; acesulfame potassium; about 3.4 pH; and further comprises one or more limitations selected from the following:

wherein the beverage comprises: about 15 to 25 mEq/L of sodium; about 4 to 22 mEq/L of chloride; about 2 to 5 mEq/L potassium; and about 3 to 24 mEq/L citrate;

wherein the electrolyte blend comprises sodium chloride, sodium bicarbonate, sodium lactate, sodium aspartate, sodium pyruvate, sodium acetate, sodium citrate, or any combination thereof;

wherein the electrolyte blend comprises calcium chloride, potassium chloride, magnesium chloride, or any combination thereof;

wherein the electrolyte blend comprises monopotassium phosphate, potassium chloride, potassium bicarbonate, or any combination thereof;

wherein the beverage comprises a weight ratio of sucralose to acesulfame potassium is about 3:1 to 5:1;

wherein the beverage comprises about 100 to 250 mg/L of sucralose; and

about 30 to 60 mg/L of acesulfame potassium;

wherein the beverage comprises a Brix of about 0.35 to 0.55;

wherein the beverage comprises a Brix of less than 0.55;

wherein the beverage comprises a Brix Equivalence of about 4 to 7;

wherein the beverage comprises about 0.15 wt. % to about 0.3 wt. % citric acid;

wherein the beverage comprises about 0.005 to 0.2 wt. % starch cloud;

wherein the beverage comprises about 0.1024 wt. % of a flavor;

wherein the flavor comprises an emulsifier;

wherein the flavor is lemon lime;

wherein the flavor is cherry lime;

wherein the flavor is orange;

wherein the flavor is fruit punch;

wherein the beverage comprises at least about 98 wt. % water; and

wherein the beverage comprises about 2 g or less carbohydrates per 240 mL.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount (i.e. 0%) is added in some embodiments.

Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

The methods disclosed herein may be suitably practiced in the absence of any element, limitation, or step that is not specifically disclosed herein. Similarly, specific product embodiments described herein may be obtained in the absence of any component not specifically described herein. Thus, the beverage described herein may consist of those listed components as described above.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

All percentages given herein are assumed to be weight percent (sometimes abbreviated wt. %) unless explicitly or contextually indicated otherwise.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the present disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A zero-sugar beverage comprising:
water;
zero sugars;
an electrolyte blend comprising 15 to 25 mEq/L sodium, 4 to 22 mEq/L chloride, 2 to 5 mEq/L potassium, and 3 to 24 mEq/L citrate;
a sufficient amount of citric acid so that the beverage has a pH of about 3.4;
about 100 to 250 mg/L sucralose and about 30 to 60 mg/L acesulfame potassium such that a weight ratio of sucralose to acesulfame potassium is about 3:1 to 5:1.

2. The zero-sugar beverage of claim 1, wherein the electrolyte blend comprises sodium chloride, sodium bicarbonate, sodium lactate, sodium aspartate, sodium pyruvate, sodium acetate, sodium citrate, or any combination thereof.

3. The zero-sugar beverage of claim 1, wherein the electrolyte blend comprises calcium chloride, potassium chloride, magnesium chloride, or any combination thereof.

4. The zero-sugar beverage of claim 1, wherein the electrolyte blend comprises monopotassium phosphate, potassium chloride, potassium bicarbonate, or any combination thereof.

5. The zero-sugar beverage of claim 1, wherein the beverage comprises a Brix of about 0.35 to 0.55.

6. The zero-sugar beverage of claim 1, wherein the beverage comprises a Brix of less than 0.55.

7. The zero-sugar beverage of claim 1, wherein the beverage comprises a Brix Equivalence of about 4 to 7.

8. The zero-sugar beverage of claim 1, wherein the beverage comprises about 0.15 wt. % to about 0.3 wt. % citric acid.

9. The zero-sugar beverage of claim 1, comprising about 0.005 to 0.2 wt. % starch cloud.

10. The zero-sugar beverage of claim 1, comprising about 0.1024 wt. % of a flavor.

11. The zero-sugar beverage of claim 10, wherein the flavor comprises an emulsifier.

12. The zero-sugar beverage of claim 10, wherein the flavor is lemon lime, cherry lime, orange, or fruit punch.

13. The zero-sugar beverage of claim 1, wherein the beverage comprises at least about 98 wt. % water.

14. The zero-sugar beverage of claim 1, wherein the beverage comprises about 2 g or less carbohydrates per 240 mL.

15.-20. (canceled)
